(19) United States
(12) Patent Application Publication
(10) Pub. No.: US 2024/0272378 A1
(43) Pub. Date: Aug. 15, 2024

(54) FERRULE

(71) Applicant: Fujikura Ltd., Tokyo (JP)

(72) Inventor: Masayuki Hirose, Sakura-shi (JP)

(73) Assignee: Fujikura Ltd., Tokyo (JP)

(21) Appl. No.: 18/682,206

(22) PCT Filed: Feb. 21, 2022
(86) PCT No.: PCT/JP2022/006840

§ 371 Date: Feb. 8, 2024

(30) Foreign Application Priority Data
Aug. 10, 2021 (JP) 2021-130614

(51) Int. Cl. G02B 6/40; G02B 6/38

(52) U.S. Cl. CPC G02B 6/403; G02B 6/3882; G02B 6/3893

(57) ABSTRACT

A ferrule includes: a ferrule main body having: a connection end surface, and fiber holes disposed in a first direction and through which optical fibers are inserted; and a protruding portion protruding from the ferrule main body in the first direction. The connection end surface faces forward in a longitudinal direction of the fiber holes. The protruding portion has a protruding-portion rear surface facing rearward in the longitudinal direction of the fiber holes. A distance in the longitudinal direction between the protruding-portion rear surface and the connection end surface is shorter than a distance in the longitudinal direction between the protruding-portion rear surface and a rear end of the ferrule main body.

### CROSS-REFERENCE TO RELATED APPLICATIONS

Priority is claimed on Japanese Patent Application No. 2021-130614 filed on Aug. 10, 2021, the content of which is incorporated herein by reference.

### TECHNICAL FIELD

The present invention relates to a ferrule.

### BACKGROUND

Patent Document 1 discloses a ferrule including a ferrule main body having a connection end surface and a plurality of fiber holes.

### PATENT LITERATURE

### Patent Document 1

Japanese Unexamined Patent Application, First Publication No. 2006-208680

As a method of connecting a ferrule to another ferrule, a method in which the two ferrules are pressed together by a fixing member such as a clip is conventionally known. However, in a configuration in which a pressing force by a fixing member is applied to a rear end of a ferrule such as a ferrule (optical connector) described in Patent Document 1, a distance between a point of application of the pressing force and the connection end surface was large. Therefore, misalignment or inclination may occur between the connection end surfaces due to the pressing force by the fixing member, and connection loss is likely to occur between the ferrules.

### SUMMARY

The present invention has been made in consideration of such circumstances, and one or more embodiments of the present invention provide a ferrule that is capable of reducing connection loss.

A ferrule according to one or more embodiments of the present invention includes a ferrule main body having a connection end surface, and a plurality of fiber holes arranged in a first direction through which a plurality of optical fibers are inserted, and a protruding portion protruding from the ferrule main body in the first direction, in which the protruding portion has a protruding-portion rear surface facing a rearward direction assuming that a direction in which the connection end surface faces is referred to as a forward direction and a direction opposite to the forward direction is referred to as the rearward direction in a longitudinal direction of the plurality of fiber holes, and a distance between the protruding-portion rear surface and the connection end surface in the longitudinal direction is shorter than a distance between the protruding-portion rear surface and a rear end of the ferrule main body in the longitudinal direction.

According to the above-described embodiments of the present invention, it is possible to provide a ferrule that is capable of reducing connection loss.

### BRIEF DESCRIPTION OF THE DRAWINGS

FIG. 1 is an overall perspective view illustrating a ferrule according to a first embodiment.

FIG. 2 is a view of the ferrule illustrated in FIG. 1 from an arrow II.

FIG. 3A is a view illustrating an example of an optical connector using the ferrule according to the first embodiment.

FIG. 3B is a view illustrating a state following FIG. 3A.

FIG. 4 is a view illustrating an optical connection structure according to a second embodiment.

FIG. 5A is an enlarged view of a part of FIG. 4.

FIG. 5B is a view illustrating a state following FIG. 5A.

FIG. 6 is a view illustrating a ferrule according to a modified example.

### DETAILED DESCRIPTION

### First Embodiment

Hereinafter, a ferrule according to a first embodiment will be described on the basis of the drawings.

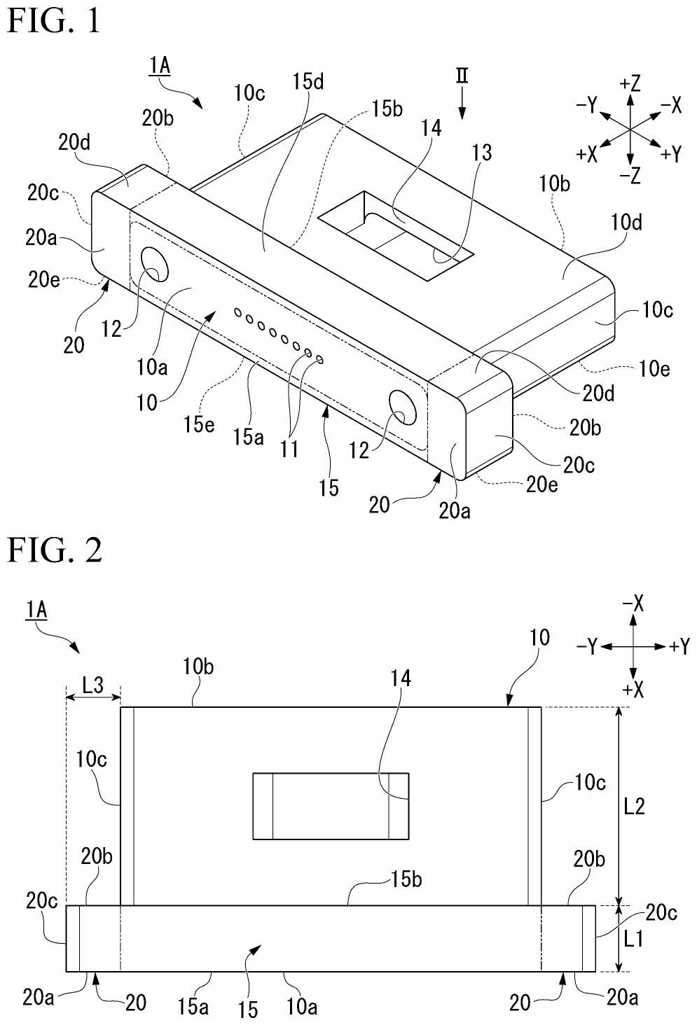

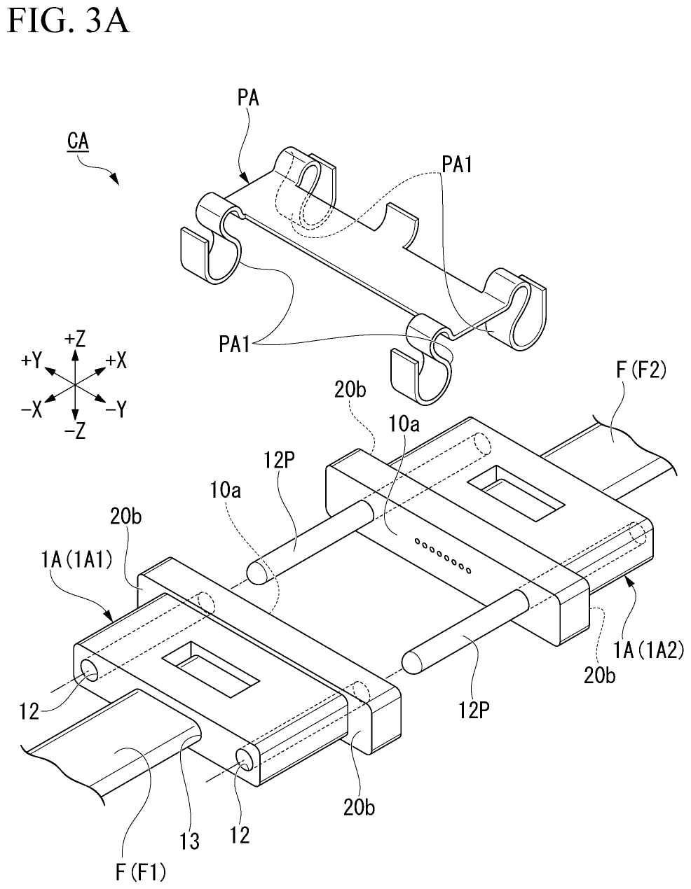

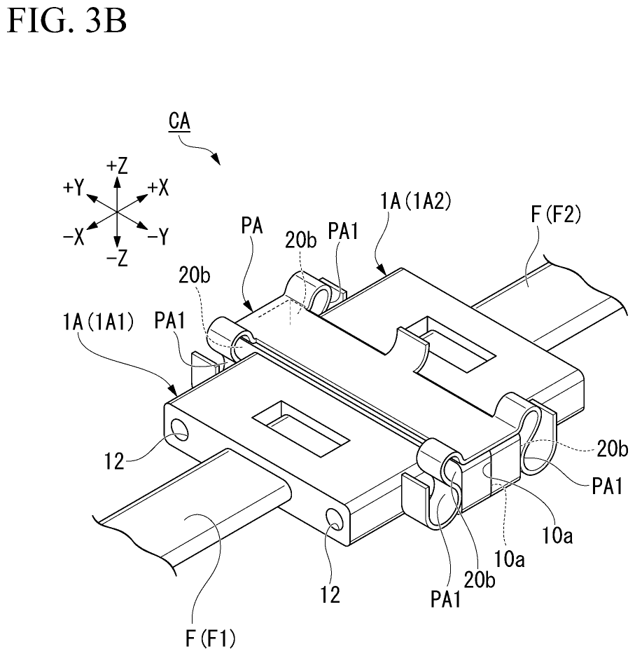

As illustrated in FIG. 1, a ferrule 1A includes a ferrule main body 10 and a pair of protruding portions 20. The ferrule main body 10 has a plurality of fiber holes 11 through which a plurality of optical fibers F (see also FIGS. 3A and 3B) are to be inserted. The plurality of fiber holes 11 are arranged in one direction orthogonal to a longitudinal direction of the fiber holes 11. Also, the ferrule main body 10 has a connection end surface 10a.

### Definition of Directions

Here, in the present embodiment, an XYZ orthogonal coordinate system may be set to describe a positional relationship of respective components. An X direction is a direction along the longitudinal direction of the fiber holes 11. A Y direction is a direction in which the plurality of fiber holes 11 are arranged. A Z direction is a direction orthogonal to both the X direction and the Y direction. In the present specification, an X-axis direction may be referred to as a longitudinal direction X, a Y-axis direction may be referred to as a first direction Y, and a Z-axis direction may be referred to as a second direction Z. In the longitudinal direction X, a direction in which the connection end surface 10a faces is referred to as a +X direction or a forward direction. A direction opposite to the +X direction is referred to as a −X direction or a rearward direction. One direction along the first direction Y is referred to as a +Y direction or a rightward direction. A direction opposite to the +Y direction is referred to as a −Y direction or a leftward direction. One direction along the second direction Z is referred to as a +Z direction or an upward direction. A direction opposite to the +Z direction is referred to as a −Z direction or a downward direction.

The ferrule main body 10 according to the present embodiment may have the connection end surface 10a (front end), a rear end surface (rear end) 10b, a pair of side surfaces 10c, an upper surface 10d, and a lower surface 10e. The connection end surface 10a faces the forward direction. The rear end surface 10b faces the rearward direction. The pair of side surfaces 10c face outward in the first direction Y. Also, an auxiliary protruding portion 15 protruding outward in the second direction Z from the upper surface 10d and the lower surface 10e is formed at a front end portion of the ferrule main body 10. The auxiliary protruding portion 15 has a front surface 15a, a rear surface 15b, an upper surface 15d, and a lower surface 15e. Note that, the ferrule main body 10 may not have the auxiliary protruding portion 15.

The plurality of fiber holes 11, a pair of guide pin holes 12, a fiber insertion hole 13, and an adhesive injection hole 14 are formed in the ferrule main body 10. The plurality of fiber holes 11 are arranged in the first direction Y. The fiber holes 11 each open on the connection end surface 10a and extend rearward from the connection end surface 10a.

In the present embodiment, the pair of guide pin holes 12 may be disposed to sandwich the plurality of fiber holes 11 from the outside in the first direction Y. The guide pin holes 12 each open on the connection end surface 10a and extend rearward from the connection end surface 10a to penetrate the ferrule main body 10. Guide pins 12P are inserted into the guide pin holes 12 (see also FIGS. 3A and 3B). The ferrule 1A illustrated in FIG. 1 and the like is a so-called female-side ferrule and has the guide pin holes 12 formed therein, but the ferrule 1A may be a so-called male-side ferrule. That is, the ferrule 1A may have the guide pins 12P. When the guide pins 12P of the male-side ferrule 1A are inserted into the guide pin holes 12 of the female-side ferrule 1A, positioning between the two ferrules 1A is performed.

The fiber insertion hole 13 is recessed forward from the rear end surface 10b to communicate with rear ends of the fiber holes 11. Also, the fiber insertion hole 13 communicates with the adhesive injection hole 14. The fiber insertion hole 13 functions as an entrance when the optical fibers F are inserted through the fiber holes 11. Guide grooves (not illustrated) for guiding the optical fibers F to the fiber holes 11 may be formed in the fiber insertion hole 13. The adhesive injection hole 14 is recessed downward from the upper surface 10d to communicate with the fiber insertion hole 13. The adhesive injection hole 14 is used when an adhesive is injected into the ferrule main body 10.

The protruding portions 20 protrude outward in the first direction Y from the ferrule main body 10. In other words, the ferrule 1A has the pair of protruding portions 20, and the pair of protruding portions 20 are disposed to sandwich the ferrule main body 10 from the outside in the first direction Y. The protruding portions 20 may be formed integrally with the ferrule main body 10. Alternatively, the protruding portions 20 may be formed separately from the ferrule main body 10 and fixed to the ferrule main body 10.

The protruding portions 20 each have a front surface (protruding-portion front surface) 20a, a rear surface (protruding-portion rear surface) 20b, a side surface 20c, an upper surface 20d, and a lower surface 20e. The front surface 20a faces the forward direction, and the rear surface 20b faces the rearward direction. The side surface 20c faces outward in the first direction Y. In the present embodiment, the upper surface 20d of the protruding portion 20 and the upper surface 15d of the auxiliary protruding portion 15 may be positioned on the same plane. Similarly, the lower surface 20e of the protruding portion 20 and the lower surface 15e of the auxiliary protruding portion 15 are positioned on the same plane. However, the upper surface 20d of the protruding portion 20 and the upper surface 15d of the auxiliary protruding portion 15 may not be positioned on the same plane. Similarly, the lower surface 20e of the protruding portion 20 and the lower surface 15e of the auxiliary protruding portion 15 may not be positioned on the same plane.

The protruding portion 20 is positioned on an outer side with respect to the guide pin hole 12 in the first direction Y. Also, the side surface 20c of the protruding portion 20 is positioned on an outer side with respect to the side surface 10c of the ferrule main body 10 in the first direction Y. If the ferrule 1A is a male-side ferrule, the protruding portion 20 may be positioned on an outer side with respect to the guide pin 12P in the first direction Y. Also, a protrusion amount of the protruding portion 20 protruding outward in the first direction Y from the ferrule main body 10 may be 0.3 mm or more. In other words, a dimension L3 (see FIG. 2) of the rear surface 20b of the protruding portion 20 in the first direction Y may be 0.3 mm or more.

As illustrated in FIG. 2, in the present embodiment, the rear surface 20b of the protruding portion 20 and the rear surface 15b of the auxiliary protruding portion 15 may be on the same plane. However, a positional relationship between the rear surface 20b of the protruding portion 20 and the rear surface 15b of the auxiliary protruding portion 15 is not limited thereto. For example, the rear surface 20b of the protruding portion 20 may be inclined with respect to the rear surface 15b of the auxiliary protruding portion 15. Alternatively, a position of the rear surface 20b of the protruding portion 20 and a position of the rear surface 15b of the auxiliary protruding portion 15 may be offset in the longitudinal direction X. In other words, the rear surface 20b of the protruding portion 20 and the rear surface 15b of the auxiliary protruding portion 15 may be stepped.

Also, a distance L1 in the longitudinal direction X between the rear surface 20b of the protruding portion 20 and the connection end surface 10a is shorter than a distance L2 in the longitudinal direction X between the rear surface 20b of the protruding portion 20 and a rear end (the rear end surface 10b) of the ferrule main body 10. In other words, the rear surface 20b of the protruding portion 20 is positioned forward of a center point of the ferrule main body 10 in the longitudinal direction X.

Also, in the present embodiment, the front surface 20a of the protruding portion 20, the front surface 15a of the auxiliary protruding portion 15, and the connection end surface 10a may be on the same plane. However, a positional relationship between the front surface 20a of the protruding portion 20 and the connection end surface 10a is not limited thereto. For example, the front surface 20a of the protruding portion 20 may be inclined with respect to the connection end surface 10a. Alternatively, a position of the front surface 20a of the protruding portion 20 and a position of the connection end surface 10a may be offset in the longitudinal direction X. In other words, the front surface 20a of the protruding portion 20 and the connection end surface 10a may be stepped. The same applies to a positional relationship between the front surface 20a of the protruding portion 20 and the front surface 15a of the auxiliary protruding portion 15.

Next, an operation of the ferrule 1A configured as described above will be described.

FIGS. 3A and 3B are views illustrating an example of an optical connector CA using the ferrule 1A according to the present embodiment. The optical connector CA includes two ferrules 1A (a first ferrule 1A1 and a second ferrule 1A2) and a fixing member (i.e., holder) PA. The plurality of optical fibers F (first optical fibers F1 and second optical fibers F2) are inserted through each of the ferrules 1A. Also, the first ferrule 1A1 is a female-side ferrule and has the guide pin holes 12. The second ferrule 1A2 is a male-side ferrule and has the guide pins 12P. When the fixing member PA is attached to the first ferrule 1A1 and the second ferrule 1A2 with the guide pins 12P inserted into the guide pin holes 12, the connection end surface 10a of the first ferrule 1A1 and the connection end surface 10a of the second ferrule 1A2 are pressed together. Thereby, the first optical fibers F1 and the second optical fibers F2 are connected.

The fixing member PA has a pressing portion (i.e., claw) PA1. When the fixing member PA is attached to the ferrules 1A1 and 1A2, the pressing portion PA1 exerts a pressing force on the ferrules 1A1 and 1A2. In the example of FIG. 3, the pressing portion PA1 is formed of an elastic member (leaf spring). Therefore, the pressing portion PA1 exerts a pressing force due to an elastic force on the ferrules 1A1 and 1A2. However, a configuration of the pressing portion PA1 is not limited to the example of FIG. 3. For example, it is also possible to employ a configuration in which the pressing portion PA1 has a screw mechanism, and the ferrules 1A1 and 1A2 are pressed together by the screw mechanism.

However, generally, the pressing force exerted by the pressing portion PA1 is often not completely parallel to the longitudinal direction X. Therefore, a moment trying to cause the connection end surface 10a of the first ferrule 1A1 to be misaligned or inclined with respect to the connection end surface 10a of the second ferrule 1A2 in the first direction Y or the second direction Z may be generated in the ferrules 1A1 and 1A2. Misalignment or inclination occurring between the connection end surface 10a of the first ferrule 1A1 and the connection end surface 10a of the second ferrule 1A2 tends to cause connection loss between the ferrules 1A1 and 1A2.

On the other hand, in the present embodiment, the pressing force from the pressing portion PA1 may be received by the rear surface 20b of the protruding portion 20. In other words, a point of application of the pressing force is positioned on the rear surface 20b of the protruding portion 20. Also, the rear surface 20b of the protruding portion 20 is positioned forward of a center point of the ferrule main body 10 in the longitudinal direction X. With this configuration, it is possible to make a distance between the point of application of the pressing force and the connection end surface 10a shorter compared to, for example, a case in which the point of application of the pressing force is on the rear end surface 10b of the ferrule main body 10. Here, a magnitude of the moment trying to cause misalignment or inclination between the first ferrule 1A1 and the second ferrule 1A2 is proportional to a distance between the connection end surface 10a and the point of application of the pressing force. Therefore, when the distance between the point of application of the pressing force and the connection end surface 10a is made short, it is possible to suppress the magnitude of the moment described above. Thereby, it is possible to suppress misalignment or inclination occurring between the connection end surface 10a of the first ferrule 1A1 and the connection end surface 10a of the second ferrule 1A2. That is, it is possible to reduce connection loss between the ferrules 1A1 and 1A2.

As described above, the ferrule 1A according to the present embodiment may include the ferrule main body 10 having the connection end surface 10a, and the plurality of fiber holes 11 arranged in the first direction Y through which the plurality of optical fibers F are inserted, and the protruding portion 20 protruding from the ferrule main body 10 in the first direction Y, in which the protruding portion 20 has the rear surface 20b facing the rearward direction assuming that a direction in which the connection end surface 10a faces is referred to as a forward direction and a direction opposite to the forward direction is referred to as a rearward direction in the longitudinal direction X of the plurality of fiber holes 11, the distance L1 between the rear surface 20b of the protruding portion 20 and the connection end surface 10a in the longitudinal direction X is shorter than the distance L2 between the rear surface 20b of the protruding portion 20 and the rear end of the ferrule main body 10 in the longitudinal direction X. Note that, the “rear end of the ferrule main body 10” means a portion positioned on a rearmost side of the ferrule main body 10, and in the present embodiment, the rear end surface 10b may correspond to the “rear end of the ferrule main body 10”.

With this configuration, it is possible to suppress occurrence of misalignment or inclination between the connection end surfaces 10a due to the pressing force when the fixing member PA is attached. Therefore, it is possible to reduce connection loss between the ferrules 1A1 and 1A2.

Also, the ferrule main body 10 further includes the guide pin hole 12 through which the guide pin 12P is to be inserted, and the protruding portion 20 is positioned on an outer side with respect to the guide pin hole 12 in the first direction Y. When the ferrule 1A (first ferrule 1A1) includes the guide pin hole 12, positioning between the ferrules 1A1 and 1A2 becomes easier. Also, since the protruding portion 20 is positioned on an outer side with respect to the guide pin hole 12 in the first direction Y, it is possible for the fixing member PA to easily grip the protruding portion 20. Thereby, it is possible to make fixing between the ferrules 1A1 and 1A2 more stable.

Note that, the ferrule main body 10 may include the guide pin 12P instead of the guide pin hole 12, and the protruding portion 20 may be positioned on an outer side with respect to the guide pin 12P in the first direction Y. Also in this case, it is possible to obtain the same operation and effect as described above.

Also, when the connection end surface 10a is connected to another connection end surface 10a using the fixing member PA having the pressing portion PA1, the rear surface 20b of the protruding portion 20 receives a pressing force by the pressing portion PA1. With this configuration, it is possible to make connection between the ferrules 1A1 and 1A2 more stable by the pressing force due to the fixing member PA.

Also, the protruding portion 20 further has the front surface 20a facing the forward direction, and the front surface 20a of the protruding portion 20 and the connection end surface 10a are on the same plane. With this configuration, a contact area when the ferrules 1A1 and 1A2 are pressed together increases compared to, for example, a case in which the front surface 20a of the protruding portion 20 and the connection end surface 10a are not on the same plane. Thereby, misalignment or inclination between the ferrules 1A1 and 1A2 does not easily occur, and it is possible to reduce connection loss more reliably.

Also, a protrusion amount of the protruding portion 20 protruding in the first direction Y from the ferrule main body 10 is 0.3 mm or more. With this configuration, an area of the rear surface 20b of the protruding portion 20 increases. Therefore, it becomes easier for the rear surface 20b of the protruding portion 20 to reliably receive the pressing force due to the fixing member PA, and it is possible to make the connection between the connection end surfaces 10a more stable. Also, an increase in area of the rear surface 20b allows to secure a size of the pressing portion PA1, and it is possible to enhance a mechanical strength of the pressing portion PA1.

### Second Embodiment

Next, a second embodiment will be described, but a basic configuration is the same as that of the first embodiment. Therefore, components which are the same are denoted by the same reference signs, description thereof will be omitted, and only different points will be described.

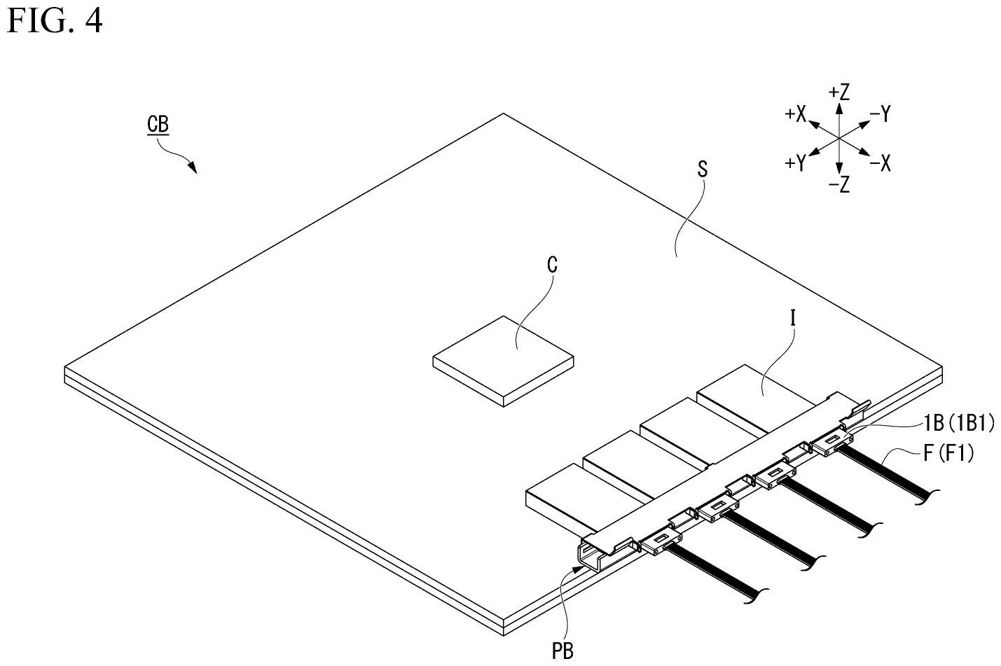

In the present embodiment, a ferrule 1B may be incorporated in an optical connection structure CB. As illustrated in FIG. 4, the optical connection structure CB includes a substrate S, a circuit C, and an optical integrated circuit I. The optical integrated circuit I has a role of bidirectionally converting an optical signal and an electrical signal. The optical connection structure CB in the present embodiment may be an optical connection structure used in so-called CPO (Co-Packaged Optics).

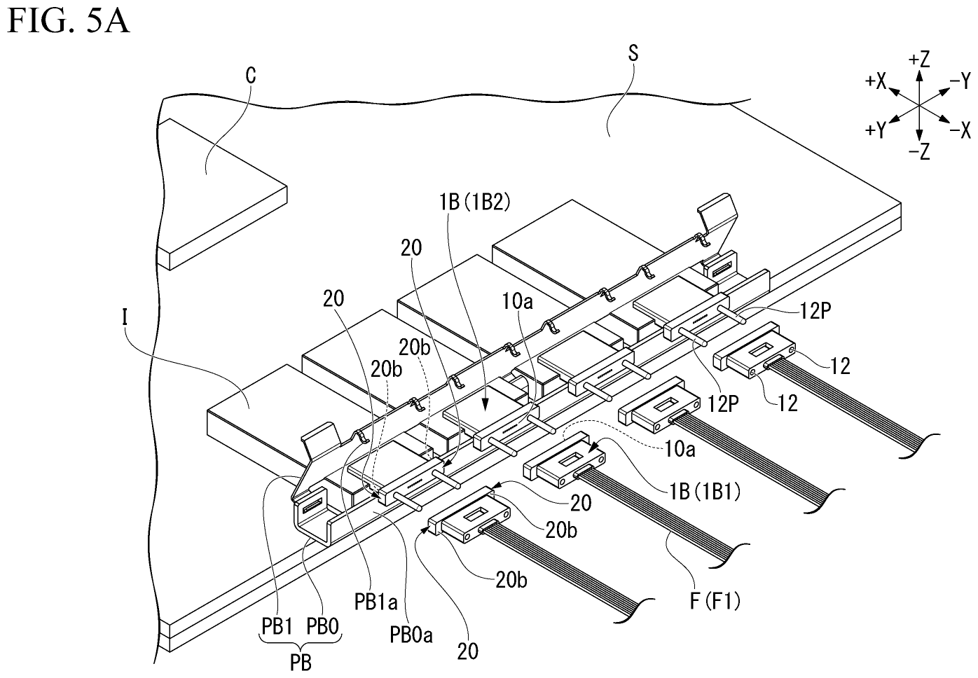

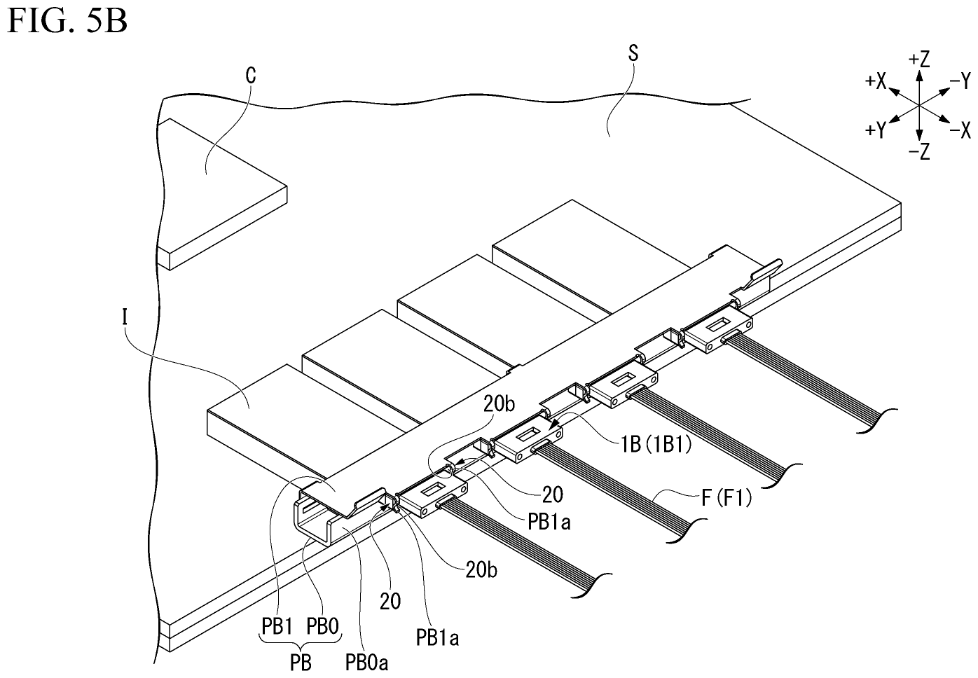

The optical connection structure CB includes a plurality of ferrules 1B. In the example of FIG. 4, the plurality of ferrules 1B include four first ferrules 1B1 and four second ferrules 1B2 (see also FIGS. 5A and 5B). The second ferrules 1B2 are each fixed to the optical integrated circuit I to be optically connected to the optical integrated circuit I. The second ferrule 1B2 may be a male-side ferrule having the same configuration as the second ferrule 1A2 in the first embodiment. The first ferrules 1B1 are each a ferrule that is optically connected to the second ferrule 1B2 by a fixing member PB (to be described later). The first ferrule 1B1 may be a female-side ferrule having the same configuration as the first ferrule 1A1 in the first embodiment. However, a configuration of the plurality of ferrules 1B is not limited to the above, and, for example, the female-side ferrule may be fixed to the optical integrated circuit I. Alternatively, both the female-side ferrule and the male-side ferrule may be fixed to the optical integrated circuit I.

As illustrated in FIG. 5A, the optical connection structure CB has the fixing member PB. The fixing member PB has a support part PB0 and a rotating part PB1. The support part PB0 is fixed to the substrate S. The rotating part PB1 is fixed to the support part PB0 to be rotatable. The rotating part PB1 has a pressing portion (first pressing portion) PB1a formed of an elastic member. The support part PB0 has a pressing portion (second pressing portion) PB0a formed in a plate shape.

As illustrated in FIG. 5B, when the rotating part PB1 is closed, the first pressing portion PB1a exerts a pressing force on a rear surface 20b of a protruding portion 20 of the first ferrule 1B1. On the other hand, the second pressing portion PB0a exerts a pressing force on a rear surface 20b of a protruding portion 20 of the second ferrule 1B2. That is, when the first ferrule 1B1 is attached to the second ferrule 1B2 so that a guide pin 12P is inserted into a guide pin hole 12, and moreover, the rotating part PB1 is closed, a connection end surface 10a of the first ferrule 1B1 and a connection end surface 10a of the second ferrule 1B2 are pressed together. Thereby, the first ferrule 1B1 and the second ferrule 1B2 (the optical integrated circuit I) are optically connected.

As described above, the ferrule 1B according to the present embodiment may also be used in so-called CPO. Here, in manufacturing the optical connection structure CB for the CPO, soldering on the substrate S is generally performed. Therefore, as a material forming the ferrule 1B, a material with high heat resistance that is capable of withstanding heat during soldering (about 250 to 260° C.) may be selected.

Also, in the ferrule 1B according to the present embodiment, since a point of application of the pressing force and the connection end surface 10a may be close to each other, it may be possible to obtain the same operation and effect as those of the ferrule 1A according to the first embodiment.

Note that, the technical scope of the present invention is not limited to the above-described embodiments, and various modifications may be made in a range not departing from the meaning of the present invention.

For example, in the embodiments described above, the pair of guide pin holes 12 (guide pins 12P) are disposed to sandwich the plurality of fiber holes 11 from the outside in the first direction Y, but a configuration of the pair of guide pin holes 12 (guide pins 12P) are not limited thereto. For example, the guide pin holes 12 (guide pins 12P) may be provided above or below the fiber holes 11. Alternatively, the ferrule main body 10 may not have the guide pin holes 12 or the guide pins 12P. The ferrule main body 10 may have a positioning mechanism other than the guide pin holes 12 or the guide pins 12P.

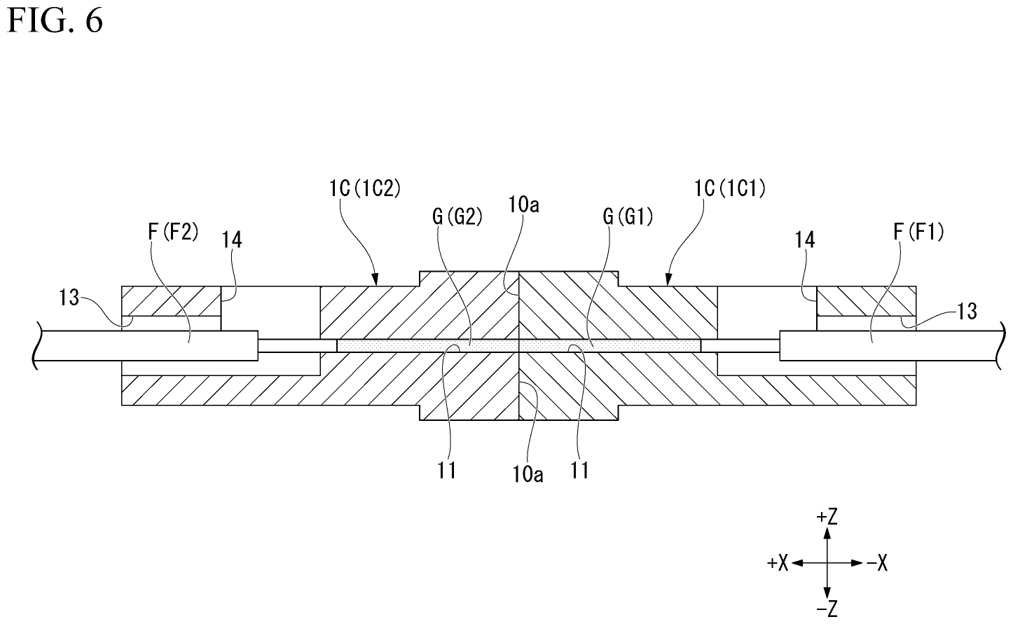

Also, as illustrated in FIG. 6, a ferrule 1C may include a gradient index lens (GRIN lens) G. In this case, the GRIN lens G may be provided inside the fiber hole 11, and a GRIN lens G1 of a first ferrule 1C1 and a GRIN lens G2 of a second ferrule 1C2 may be optically connected. Also, the GRIN lens G and the optical fiber F may be connected by an adhesive or fusion. In this case, it is possible to shape an optical signal that has been propagated inside the optical fiber F into parallel light, and it is possible to suppress leakage of the optical signal between the connection end surfaces 10a. That is, it is possible to further reduce connection loss between the connection end surfaces 10a.

In addition, the components in the above-described embodiments may be appropriately replaced with well-known components within a range not departing from the meaning of the present invention, and the embodiments and modified examples described above may be appropriately combined.

For example, in the optical connection structure CB described in the second embodiment, the ferrule 1C having the GRIN lens described as a modified example may be used.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### REFERENCE SIGNS LIST

1A, 1B, 1C Ferrule
10 Ferrule main body
10a Connection end surface
10b Rear end surface (rear end)
11 Fiber hole
12 Guide pin hole
12P Guide pin
20 Protruding portion
20a Front surface (protruding-portion front surface)
20b Rear surface (protruding-portion rear surface)
PA, PB Fixing member (holder)
PA1, PB0a, PB1a Pressing portion (claw)
F Optical fiber
X Longitudinal direction
Y First direction

1. A ferrule, comprising:
a ferrule main body having:
a connection end surface; and
fiber holes disposed in a first direction and through which optical fibers are inserted; and
a protruding portion protruding from the ferrule main body in the first direction, wherein
the connection end surface faces forward in a longitudinal direction of the fiber holes,
the protruding portion has a protruding-portion rear surface facing rearward in the longitudinal direction of the fiber holes, and
a distance in the longitudinal direction between the protruding-portion rear surface and the connection end surface is shorter than a distance in the longitudinal direction between the protruding-portion rear surface and a rear end of the ferrule main body.

2. The ferrule according to claim 1, wherein
the ferrule main body further has a guide pin hole through which a guide pin is configured to be inserted, and
the protruding portion is disposed on an outer side in the first direction with respect to the guide pin hole.

3. The ferrule according to claim 1, wherein, when a holder comprising a claw connects the connection end surface to a connection end surface of another ferrule, the protruding-portion rear surface receives a pressing force by the claw.

4. The ferrule according to claim 1, wherein
the protruding portion further has a protruding-portion front surface facing forward in the longitudinal direction, and
the protruding-portion front surface and the connection end surface are on a same plane.

5. The ferrule according to claim 1, wherein a protrusion amount of the protruding portion protruding in the first direction from the ferrule main body is 0.3 mm or more.
